(19) United States
(12) Patent Application Publication
(10) Pub. No.: US 2017/0374321 A1
(43) Pub. Date: Dec. 28, 2017

(54) Video Surveillance System

(71) Applicant: Dominique Ross, Dallas, TX (US)

(72) Inventor: Dominique Ross, Dallas, TX (US)

(21) Appl. No.: 15/191,641

(22) Filed: Jun. 24, 2016

(51) Int. Cl. H04N 7/18; H04N 5/225; H04N 5/247; H04N 5/77

(52) U.S. Cl. CPC H04N 7/181; H04N 5/772; H04N 5/2253; H04N 5/247

(57) ABSTRACT

A video surveillance system includes an electronic device that may be carried. A helmet is provided and the helmet may be worn. A video unit is provided and the video unit is coupled to the helmet. Thus, the video unit may record video footage when the helmet is worn. The video unit is in electrical communication with the electronic device. Thus, the electronic device may display the video footage in real time.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to surveillance devices and more particularly pertains to a new surveillance device for monitoring video footage with respect to a helmet in real time.

### BRIEF SUMMARY OF THE INVENTION

An embodiment of the disclosure meets the needs presented above by generally comprising an electronic device that may be carried. A helmet is provided and the helmet may be worn. A video unit is provided and the video unit is coupled to the helmet. Thus, the video unit may record video footage when the helmet is worn. The video unit is in electrical communication with the electronic device. Thus, the electronic device may display the video footage in real time.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a video surveillance system according to an embodiment of the disclosure.

FIG. 2 is a front view of an embodiment of the disclosure.

FIG. 3 is a back view of an embodiment of the disclosure.

FIG. 4 is a perspective phantom view of an embodiment of the disclosure.

FIG. 5 is a right side perspective view of an embodiment of the disclosure.

### DETAILED DESCRIPTION OF THE INVENTION

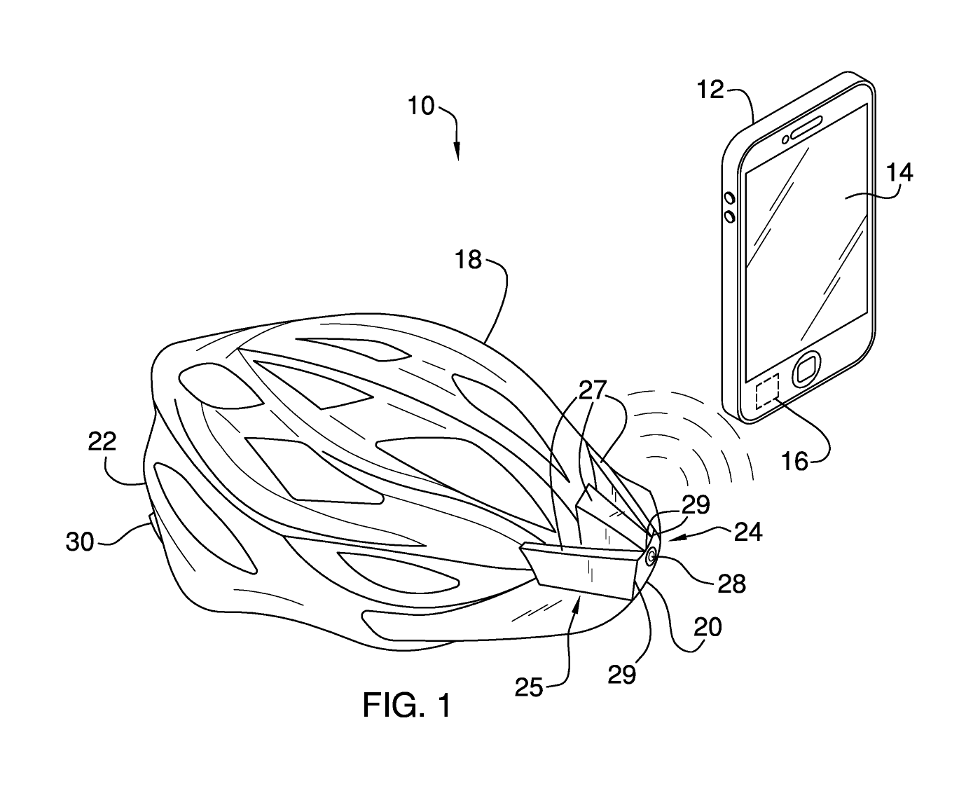

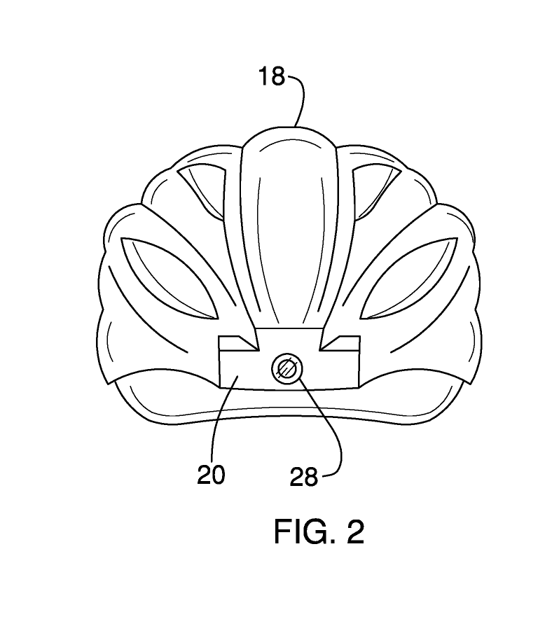

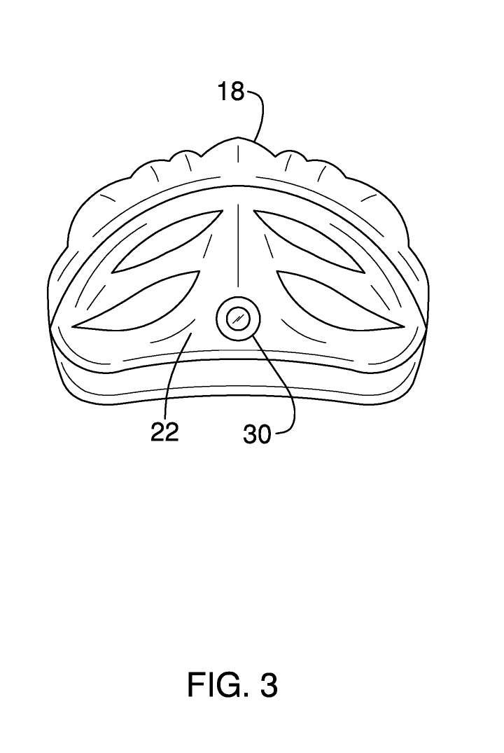

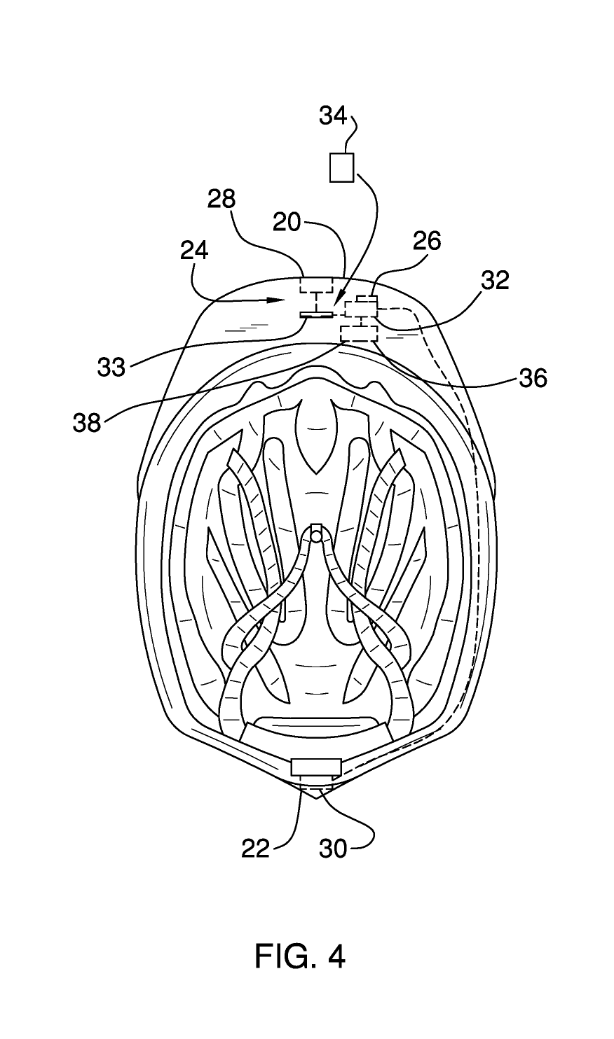

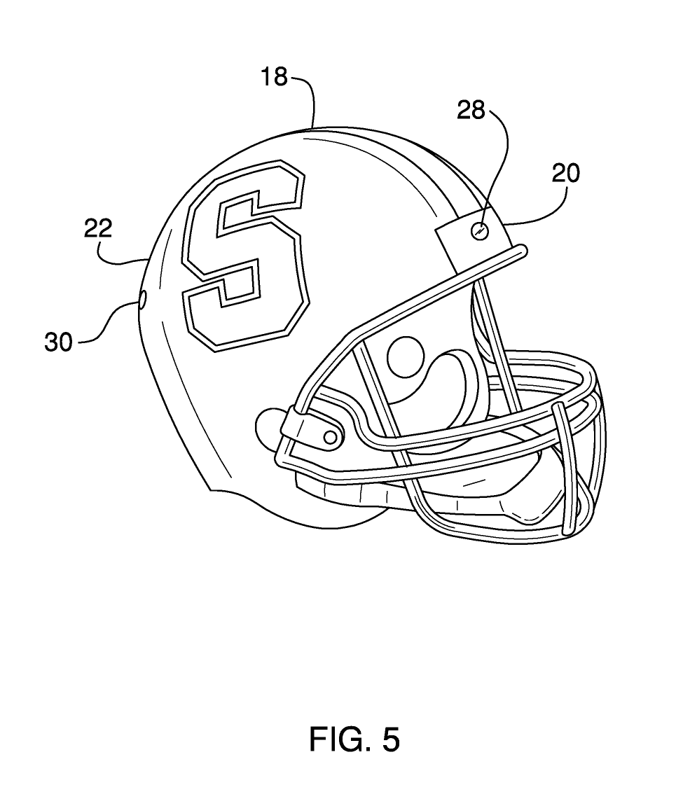

With reference now to the drawings, and in particular to FIGS. 1 through 5 thereof, a new surveillance device embodying the principles and concepts of an embodiment of the disclosure and generally designated by the reference numeral 10 will be described.

As best illustrated in FIGS. 1 through 5, the video surveillance system 10 generally comprises an electronic device 12 that has a display 14 and a transceiver 16. The electronic device 12 may be carried by a first user. The electronic device 12 may comprise a smart phone or other hand held electronic device 12. The display 14 may be a LCD or the like and the transceiver 16 may be a radio frequency transceiver 16.

A helmet 18 is provided. The helmet 18 may be worn by a second user. The helmet 18 has a front side 20 and a back side 22. The helmet 18 may comprise a bicycle helmet, a football helmet, a fireman's helmet or other helmet 18 worn to protect against head injury.

A video unit 24 is coupled to the helmet 18. The video unit 24 may record video footage when the helmet 18 is worn. The video unit 24 is in electrical communication with the electronic device 12. Thus, the electronic device 12 may display 14 the video footage in real time.

The video unit 24 includes a processor 26 that is coupled to the helmet 18. The processor 26 may be an electronic processor or the like. A first video camera 28 is provided. A second video camera 30 is provided. Each of the first video camera 28 and the second video camera 30 are electrically coupled to the processor 26.

The first video camera 28 is coupled to the front side 20 of the helmet 18. Thus, the first video camera 28 may record video footage in front of the helmet 18. The second video camera 30 is coupled to the back side 22 of the helmet 18. Thus, the second video camera 30 may record video footage behind the helmet 18. Each of the first video camera 28 and the second video camera 30 may comprise a digital video camera or the like. Moreover, each of the first video camera 28 and the second video camera 30 may comprise an infrared camera or the like.

A mount 25 may be provided and the mount 25 may be coupled to the front side 20 of the helmet 18. The mount 25 may comprise a plurality of arms 27. Each of the arms 27 may be coupled to and extend forwardly from the front side 20 of the helmet 18. Each of the arms 27 may have a distal end 29 with respect to the front side 20. The distal end 29 corresponding to each of the arms 27 may intersect. The first video camera 28 may be positioned at the intersection of each of the arms 27.

A transmitter 32 is provided and the transmitter 32 is coupled to the helmet 18. The transmitter 32 is electrically coupled to the processor 26. The transmitter 32 is in electrical communication with the transceiver 16. The transmitter 32 communicates the video footage from each of the first video camera 28 and the second video camera 30 to the electronic device 12. Thus, the video footage may be viewed on the display 14 of the electronic device 12 in real time. Each of the first video camera 28 and the second video camera 30 are structurally integrated into the helmet 18. Thus, each of the first video camera 28 and the second video camera 30 are inhibited from being damaged from an impact.

A card reader 33 is provided. The card reader 33 is coupled to the helmet 18 and the card reader 33 may insertably receive a data card 34. The card reader 33 is electrically coupled to the processor 26. The card reader 33 may comprise an SD card reader or the like. The data card 34 may store the video footage recorded by each of the first video camera 28 and the second video camera 30. Moreover, the data card 34 may be manipulated to download the video footage to an extrinsic electronic device 12.

A power supply 36 is provided. The power supply 36 is coupled to the helmet 18. The power supply 36 is electrically coupled to the processor 26. The power supply 36 comprises at least one battery 38.

The electronic device 12 may store a control program. The control program may control operational parameters of the video unit 24. The control program may turn each of the first video camera 28 and the second video camera 30 on and off. The control program may comprise a smart phone app or the like.

In use, the helmet 18 is worn by the second user. The electronic device 12 is manipulated by the first user. The control program is manipulated to turn on each of the first video camera 28 and the second video camera 30. Thus, each of the first video camera 28 and the second video camera 30 begins recording the video footage. The video footage is viewed in real time on the display 14 of the electronic device 12. The video unit 24 facilitates the first user to monitor the activities of the second user.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A video surveillance system comprising:
an electronic device being configured to be carried;
a helmet being configured to be worn; and
a video unit being coupled to said helmet wherein said video unit is configured to record video footage when said helmet is worn, said video unit being in electrical communication with said electronic device wherein said electronic device is configured to display the video footage in real time.

2. The system according to claim 1, wherein said video unit comprises a processor being coupled to said helmet.

3. The system according to claim 2, further comprising:
said helmet having a front side; and
a first video camera being coupled to said front side of said helmet wherein said first video camera is configured to record video footage in front of said helmet, said first video camera being electrically coupled to said processor.

4. The system according to claim 2, further comprising:
said helmet having a back side; and
a second video camera being coupled to said back side of said helmet wherein said second video camera is configured to record video footage behind said helmet, said second video camera being electrically coupled to said processor.

5. The system according to claim 2, further comprising:
a first video camera;
a second video camera; and
a transmitter being coupled to said helmet, said transmitter being electrically coupled to said processor, said transmitter being in electrical communication with said transceiver wherein said transmitter is configured to communicate the video footage from each of said first video camera and said second video camera to said electronic device thereby facilitating the video footage to be viewed on said display.

6. The system according to claim 2, further comprising a card reader being coupled to said helmet wherein said card reader is configured to insertably receive a data card, said card reader being electrically coupled to said processor.

7. The system according to claim 2, further comprising a power supply being coupled to said helmet, said power supply being electrically coupled to said processor, said power supply comprising at least one battery.

8. A video surveillance system comprising:
an electronic device having a display and a transceiver, said electronic device being configured to be carried;
a helmet being configured to be worn, said helmet having a front side and a back side; and
a video unit being coupled to said helmet wherein said video unit is configured to record video footage when said helmet is worn, said video unit being in electrical communication with said electronic device wherein said electronic device is configured to display the video footage in real time, said video unit comprising:
a processor being coupled to said helmet,
a first video camera being coupled to said front side of said helmet wherein said first video camera is configured to record video footage in front of said helmet, said first video camera being electrically coupled to said processor,
a second video camera being coupled to said back side of said helmet wherein said second video camera is configured to record video footage behind said helmet, said second video camera being electrically coupled to said processor,
a transmitter being coupled to said helmet, said transmitter being electrically coupled to said processor, said transmitter being in electrical communication with said transceiver wherein said transmitter is configured to communicate the video footage from each of said first video camera and said second video camera to said electronic device thereby facilitating the video footage to be viewed on said display,
a card reader being coupled to said helmet wherein said card reader is configured to insertably receive a data card, said card reader being electrically coupled to said processor, and
a power supply being coupled to said helmet, said power supply being electrically coupled to said processor, said power supply comprising at least one battery.
